(19) United States
(12) Patent Application Publication
(10) Pub. No.: US 2022/0101855 A1
(43) Pub. Date: Mar. 31, 2022

(54) SPEECH AND AUDIO DEVICES

(71) Applicant: HEWLETT-PACKARD DEVELOPMENT COMPANY, L.P., Spring, TX (US)

(72) Inventors: Fred C. Thomas, III, Fort Collins, CO (US); Bruce E. Blaho, Fort Collins, CO (US); Charles R. Shilling, Fort Collins, CO (US)

(73) Assignee: HEWLETT-PACKARD DEVELOPMENT COMPANY, L.P., Spring, TX (US)

(21) Appl. No.: 17/038,714

(22) Filed: Sep. 30, 2020

(51) Int. Cl. G10L 15/25; G10L 15/26

(52) U.S. Cl. CPC G10L 15/25; G10L 15/26

(57) ABSTRACT

An example computing device includes a display, and a parametric speaker array operatively connected to the display. The parametric speaker array is to focus audio output to a localized area adjacent to the display. A camera is operatively connected to the display. The camera is set to capture lip movements of a user in the localized area. A processor is operatively connected to the display. The processor is to convert the lip movements into text and speech.

### BACKGROUND

A computer may be used for online communication such as video conferencing. In a video conference, audio may be output for a user of the computer. Also, the computer may capture a video of the user in the video conference.

### BRIEF DESCRIPTION OF THE DRAWINGS

The following detailed description references the drawings, in which:

FIG. 1 is a block diagram illustrating a computing device that focuses audio, according to an example.

FIG. 2 is a block diagram illustrating the computing device of FIG. 1 with a microphone, according to an example.

FIG. 3 is a block diagram illustrating aspects of the camera of the computing device of FIG. 1, according to an example.

FIG. 4 is a block diagram illustrating aspects of the parametric speaker array of the computing device of FIG. 1, according to an example.

FIG. 5 is a block diagram illustrating an arrangement of a rotatable bar with respect to the computing device of FIG. 1, according to an example.

FIG. 6 is a schematic diagram illustrating an electronic device focusing audio and transcribing speech patterns, according to an example.

FIG. 7 is a schematic diagram illustrating aspects of the parametric speaker array of the electronic device of FIG. 6, according to an example.

FIG. 8 is a schematic diagram illustrating aspects of the camera array of the electronic device of FIG. 6, according to an example.

FIG. 9 is a schematic diagram illustrating aspects of the microphone array of the electronic device of FIG. 6, according to an example.

FIG. 10A is a block diagram illustrating a system to convert lip movements into text and speech using a computing device, according to an example.

FIG. 10B is a block diagram illustrating a system to generate text and speech using a computing device, according to an example.

FIG. 100 is a block diagram illustrating a system to generate text using a computing device, according to an example.

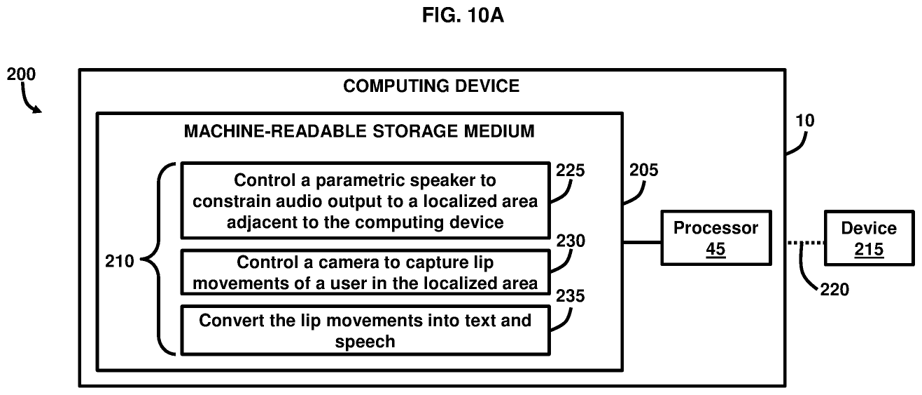

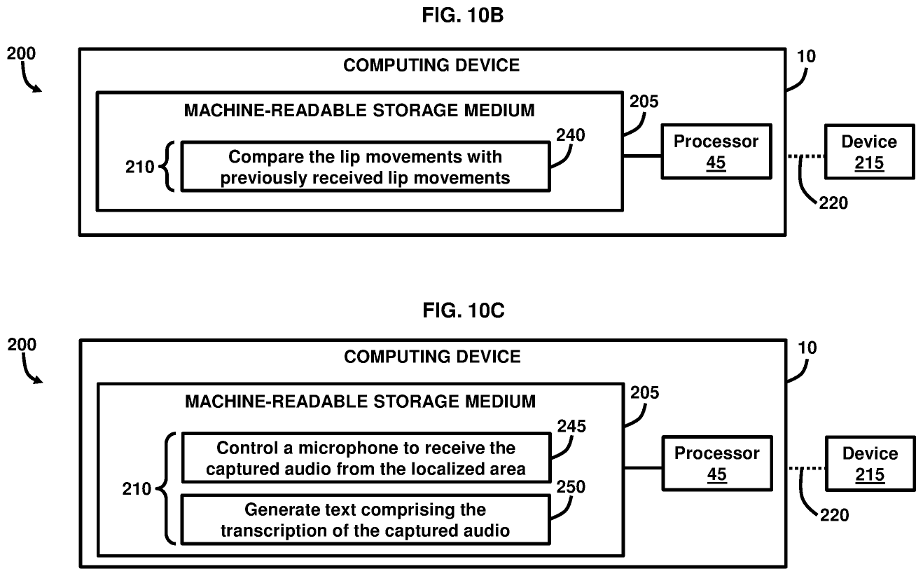

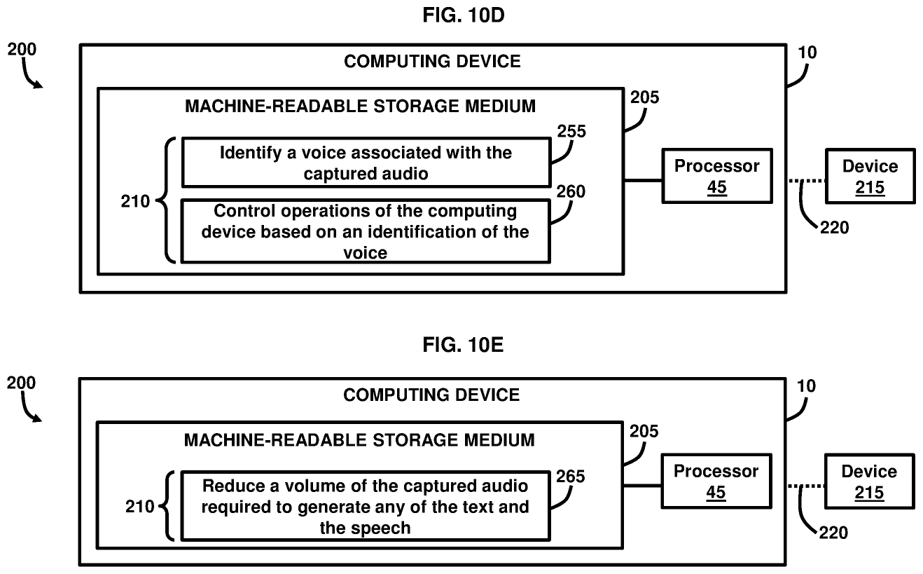

FIG. 10D is a block diagram illustrating a system to control operations of a computing device, according to an example.

FIG. 10E is a block diagram illustrating a system to control a volume of captured audio using a computing device, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In work environments interacting with a voice assistant or communicating on a voice conference call can be a noisy process that can disturb the work environment of others by creating excess and distracting noise in the environment. Ancillary to this, when interacting with artificial intelligence (AI) driven electronic voice agents such as Alexa® software (available from Amazon Technologies, Washington, USA), assistant.ai® software (available from Google LLC, California, USA), Cortana® software (available from Microsoft Corporation, Washington, USA), WeChat® software (available from Tencent Holdings Limited, George Town, Cayman Islands), and Siri® software (available from Apple Inc., California, USA), among others, it is highly useful to have accurate voice to text transcriptions to make the supporting devices more effective and have user review of any failings to improve the functionality via improved machine learning mechanisms. Moreover, video conferencing solutions may rely predominantly on universal serial bus (USB) or Bluetooth® connections via audio headsets. However, using these types of connections may be uncomfortable for some users, may provide an unnatural feeling of having devices placed in a user's ears, may not provide sufficient audio recognition for whispered or low voice interaction, may not provide a sufficiently accurate real-time or saved voice transcription, and may require additional hardware and/or software to provide for the computer voice interaction.

To overcome these challenges, an example provides a combination of components used to improve video conference calling using a computing and/or electronic device and to make interaction with electronic voice agents less intrusive in a multi-occupant environment. A camera in combination with a processor is used to perform lip reading of a user and to use voice recognition techniques to generate text and speech based on the lip reading. Artificial intelligence may be used by the processor to improve the learning of speech patterns to improve the text and speech for subsequent uses. A parametric speaker is used to output audio received during the conference call into a limited area; i.e., a sound lobe adjacent to the computing or electronic device, which allows a user to hear the audio, but prevents anyone positioned outside the sound lobe from hearing the audio. The techniques described by the examples below improve the user experience by eliminating the need for headsets, and the lip reading functionalities allows the user to lower his/her voice volume while speaking, which may be helpful in public environments, but still permits the system to understand and generate text and speech based on the lip reading and identification of the detected speech patterns.

An example provides a computing device comprising a display, and a parametric speaker array operatively connected to the display. The parametric speaker array is to focus audio output to a localized area adjacent to the display. The computing device also comprises a camera operatively connected to the display. The camera is set to capture lip movements of a user in the localized area. The computing device also comprises a processor operatively connected to the display. The processor is to convert the lip movements into text and speech. The computing device may comprise a microphone to perform directional voice detection and ambient noise reduction from the localized area. The camera may comprise a three-dimensional (3D) stereoscopic camera. The parametric speaker array may comprise a first speaker and a second speaker positioned on the display. The camera may be positioned on the display. The computing device may comprise a rotatable bar operatively connected to the display. The parametric speaker array, the camera, and the microphone may be arranged on the rotatable bar.

Another example provides an electronic device comprising a display, and a parametric speaker array attached to the display. The parametric speaker array is to focus audio output to a localized area adjacent to the display. The localized area is set to accommodate a user. The electronic device also comprises a camera array attached to the display. The camera array is to detect lip movements of the user. The electronic device also comprises a microphone array attached to the display. The microphone array is to receive audio input from within the localized area and perform directional voice detection and ambient noise reduction from the localized area. The electronic device also comprises a processor operatively connected to the display. The processor is to identify speech patterns from the lip movements detected by the camera array and from the audio input received by the microphone array; transcribe the speech patterns into text; and transmit the text and audio input from the localized area.

The parametric speaker array may comprise a first speaker positioned on the display, and a second speaker positioned on the display. The first speaker and the second speaker are selectively positioned to generate a sound lobe containing the localized area. The audio output outside of the sound lobe may be diminished compared with the audio output within the sound lobe. The camera array may comprise a first camera positioned on the display, and a second camera positioned on display. The first camera and the second camera may be selectively positioned to collectively capture the lip movements from different angles. The camera array may capture a 3D rendering of the user. The microphone array may comprise a first microphone positioned on the display, and a second microphone positioned on the display. The first microphone and the second microphone may be selectively positioned to receive the audio input from within the localized area and filter audio detected from outside the localized area.

Another example provides a machine-readable storage medium comprising computer-executable instructions that when executed cause a processor of a computing device to control a parametric speaker to constrain audio output to a localized area adjacent to the computing device; control a camera to capture lip movements of a user in the localized area; and convert the lip movements into text and speech. The instructions, when executed, may further cause the processor to compare the lip movements with previously received lip movements to improve an accuracy of a transcription of captured audio by using artificial intelligence to generate any of the text and the speech. The instructions, when executed, may further cause the processor to control a microphone to receive the captured audio from the localized area; and generate text comprising a transcription of the captured audio. The instructions, when executed, may further cause the processor to identify a voice associated with the captured audio; and control operations of the computing device based on an identification of the voice. The instructions, when executed, may further cause the processor to reduce a volume of the captured audio required to generate any of the text and the speech.

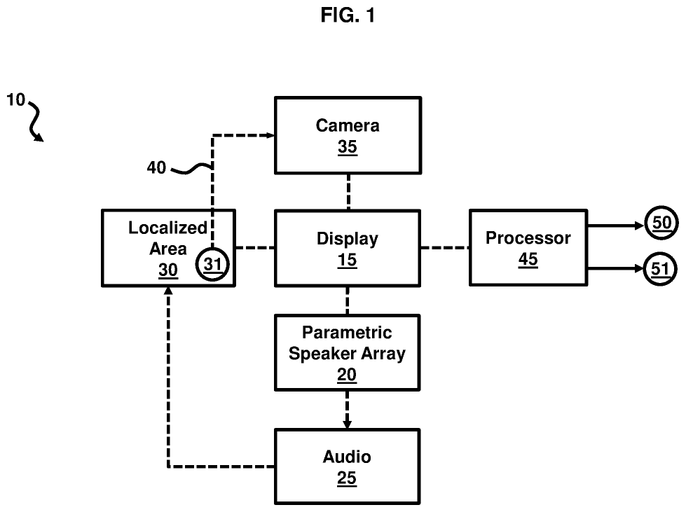

FIG. 1 illustrates a computing device 10 comprising a display 15. In some examples, the computing device 10 may comprise a smartphone, a tablet computer, a laptop computer, a desktop computer, or an all-in-one (AIO) computer, etc. The computing device 10 may be an integrated computer comprising a computing/processing portion and the display portion; i.e., the display 15. As an AIO computer, the computing device 10 may be positioned on a table or desk without the need for space for a bulky computing tower or other case typical of desktop computers since the computing/processing portion is integrated with the display portion. The computing device 10 may comprise any suitable size, shape, and configuration. In an example, the computing device 10 may be used as a video conferencing tool to permit remote communications between communicatively linked devices. Moreover, the computing device 10 may be arranged to be coupled/docked with external components, peripherals, and devices. The display 15 may be any suitable type of display device including flat panel displays, curved displays, touchscreen displays, liquid crystal displays (LCDs), light-emitting diode (LED) displays, or a combination thereof.

A parametric speaker array 20 is operatively connected to the display 15. In an example, the parametric speaker array 20 may be attached to the display 15 or embedded into the framing/housing of the display 15. The parametric speaker array 20 may include a speaker or a set of speakers that operate in the ultrasonic frequencies; i.e., above approximately 20 kHz and use modulated ultrasonic transducers, a drive circuit, and an audio source linked to the computing device 10 to transmit ultrasonic beams to selectively modulate air to provide directional output of audio 25. In an example, the drive circuit may comprise a power supply, a pulse width modulator, an amplifier, and an H-bridge switch, not shown. Signal processing techniques may be used to control the parametric speaker array 20 to isolate a region where the audio 25 is to be focused or localized. Accordingly, the parametric speaker array 20 is to focus audio 25 output to a localized area 30 adjacent to the display 15.

The localized area 30 is a defined or controlled location, region, zone, bubble, field, or lobe that is created near the display 15 using a static/fixed or dynamic approach of focusing the audio 25 that is output from the parametric speaker array 20, and the audio 25 is localized or restricted to this localized area 30 due to the modulation of the audio 25 produced by the parametric speaker array 20. In a static/fixed approach, a user 31 is placed or is otherwise located in a predictable location so that the location, region, zone, bubble, field, or lobe may be created based on the location of the user 31; i.e., a selected circumference or other suitable shape around the user 31, etc. In a dynamic approach, an ultrasonic phased array is used to shape the location, region, zone, bubble, field, or lobe, which provides some flexibility in case the user 31 moves around. Either the static/fixed or dynamic approach may utilize selective positioning and aiming of the speaker(s) in the parametric speaker array 20 to control the propagation of the audio 25 in the localized area 30. Moreover, the audio frequency, positioning of the parametric speaker array 20, and other operational parameters of the parametric speaker array 20 may be adjusted on a case-by-case basis to control the location, region, zone, bubble, field, or lobe defining the localized area 30. By directionally controlling the audio 25 that is output by the parametric speaker array 20, a private listening environment may be created in the localized area 30 allowing only a user 31 or others located in the localized area 30 to receive the audio 25. In this regard, the parametric speaker array 20 may be rotated or may be otherwise movable to more selectively direct the focus of the audio 25 to be output by the parametric speaker array 20, which controls the position and limits of the localized area 30. In an example, the localized area 30 may be a substantially elongated lobe or cone-shaped area immediately in front of the display 15 and extending approximately four meters in length and progressively increasing in width from approximately 0.5-2 meters in width, although other shapes, sizes, and configurations are possible. According to an example, the overall localized area 30 may have regions that provide audio 25 that are clearer than audio 25 in other regions in terms of sound quality, clarity, volume, etc. For example, the region of the localized area 30 that is immediately in front of the display 15 extending approximately two meters in length may provide audio 25 that is clearer than other regions of the localized area 30, and it is in this region of focused audio 25 where the user 31 may be positioned.

A camera 35 is operatively connected to the display 15. According to an example, the camera 35 may be attached to the display 15 or embedded into the framing/housing of the display 15. In an example, the camera 35 may be a digital camera having any suitable resolution, a webcam, network camera, or other type of camera that may be embedded in the computing device 10 or attached to the computing device 10 and that may be used to capture images and/or video. Furthermore, the camera 35 may comprise multiple cameras and any suitable arrangement of sub-components to house the electronics and optics to operate the camera 35. The camera 35 is set to capture lip movements 40 of the user 31 in the localized area 30. Accordingly, the camera 35 may be selectively positioned to have a clear view of the lip movements 40 of the user 31. The lip movements 40 may be captured based on the shape produced by the lips of a user 31. Moreover, the camera 35 may capture images, video, or a combination thereof to capture the lip movements 40.

A processor 45 is operatively connected to the display 15. The processor 45 may be a digital signal processor, media processor, microcontroller, microprocessor, embedded processor, or other suitable type of processor, according to some examples. In an example, the processor 45 may control the automatic operations of the display 15, parametric speaker array 20, camera 35, or a combination thereof without the need of user intervention by programming the processor 45 with controlling instructions to operate the display 15, parametric speaker array 20, camera 35, or a combination thereof. The processor 45 is to convert the lip movements 40 into text 50 and speech 51 using an artificial intelligence model such as deep learning or machine learning that is trained to receive the lip movements 40 captured by the camera 35, analyze the shapes and configurations of the lips of the user 31, analyze the lip movements 40 as a sequence of images or a video, and create a representation of the lip movements 40 in the form of text 50 and speech 51. According to an example, the text 50 and speech 51 may be generated in real-time by the processor 45.

The text 50 and speech 51 may be saved in memory, not shown, and which may be locally stored on the computing device 10 or remotely stored; i.e., in the cloud or remote memory, etc. The artificial intelligence model executable by the processor 45 may utilize previously received lip movements in the form of images, video, or a combination thereof from the same or different user to become trained into learning and mimicking the patterns created by the lip movements 40 of the user 31 to generate the text 50 and speech 51. In another example, the artificial intelligence model executable by the processor 45 may utilize programmed computer-generated lip positions associated with specific words or sounds to compare with the lip movements 40 captured by the camera 35, which is then used to generate the text 50 and speech 51. According to an example, the text 50 may be presented on the display 15. In another example, the speech 51 may be transmitted by the computing device 10 to a communicatively linked device that is being used remotely in a video conferencing arrangement to be output by the communicatively linked device for the local user of that device.

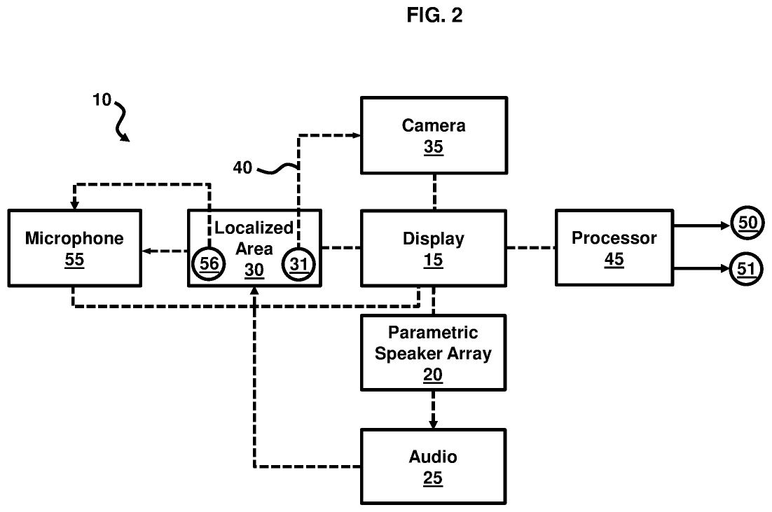

FIG. 2, with reference to FIG. 1, illustrates that the computing device 10 may comprise a microphone 55 operatively connected to the display 15. In an example, the microphone 55 may be attached to the display 15 or embedded into the framing/housing of the display 15. According to some examples, the microphone 55 may be a USB, condenser, plug and play, or other suitable type of audio-capturing device. In this regard, the microphone 55 may capture audio 56 from the localized area 30. The microphone 55 has directional sensitivity capabilities based on a positioning of the microphone 55 as well as using multiple microphones, according to an example, that are spaced apart to permit voice input from the user 31 into some of the microphones and ambient noise input into the other microphones, which effectively cancels the ambient noise from being received and processed by the processor 45. Accordingly, the microphone 55 is to perform directional voice detection and ambient noise reduction or cancelation from the localized area 30. In an example, the processor 45 may control the automatic operations of the microphone 55 without the need of user intervention by programming the processor 45 with controlling instructions to operate the microphone 55. The processor 45 may generate the text 50 and speech 51 with or without the use of the microphone 55. In an example, the microphone 55 may be used to capture the audio 56 of a user 31 and combined with the lip movements 40 captured by the camera 35 to help train the artificial intelligence model executable by the processor 45 and improve the generation and accuracy of the text 50 and speech 51.

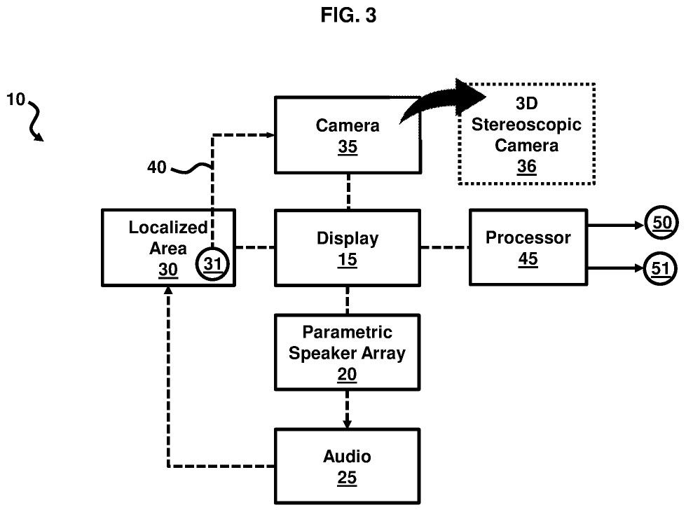

FIG. 3, with reference to FIGS. 1 and 2, illustrates that the camera 35 may comprise a 3D stereoscopic camera 36. The 3D stereoscopic camera 36 may be attached to the display 15 or embedded into the framing/housing of the display 15. In an example, the processor 45 may control the automatic operations of the 3D stereoscopic camera 36 without the need of user intervention by programming the processor 45 with controlling instructions to operate the 3D stereoscopic camera 36. According to an example, the 3D stereoscopic camera 36 comprises multiple lenses that provide two offset images or video. The processor 45 may combine the offset images into an image or video containing 3D depth. The 3D stereoscopic camera 36 may be utilized for capturing the lip movements 40 of the user 31, which may aid in improving the generation of the text 50 and speech 51 due to the 3D images or video of the lip movements 40 being robust and accurate representations of the lip movements 40. In this regard, the artificial intelligence model executable by the processor 45 may be trained using the 3D images and/or video captured by the 3D stereoscopic camera 36.

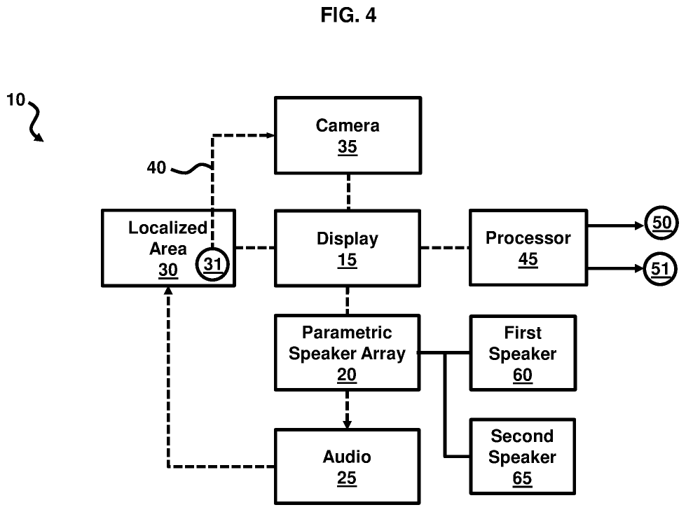

FIG. 4, with reference to FIGS. 1 through 3, illustrates that the parametric speaker array 20 may comprise a first speaker 60 and a second speaker 65 positioned on the display 15. The first speaker 60 and the second speaker 65 may be attached to the display 15 or embedded into the framing/housing of the display 15. Moreover, the camera 35 may be positioned on the display 15 such that the parametric speaker array 20 and camera 35 may be respectively spaced apart and positioned at any suitable location on the display 15; i.e., top, side, bottom, front, back, etc. The first speaker 60 and the second speaker 65 may be suitably positioned and/or spaced apart from each other to provide directional audio 25 to the localized area 30. The first speaker 60 and the second speaker 65 may both operate in the ultrasonic frequencies; i.e., above approximately 20 kHz and may both use modulated ultrasonic transducers, a drive circuit, and an audio source linked to the computing device 10 to transmit ultrasonic beams to selectively modulate air to provide directional output of audio 25. In an example, the drive circuit may comprise a power supply, a pulse width modulator, an amplifier, and an H-bridge switch, not shown. Signal processing techniques may be used to control the first speaker 60 and the second speaker 65 to isolate a region in the localized area 30 where the audio 25 is to be focused or localized. Moreover, the first speaker 60 and the second speaker 65 may be used in a complimentary manner to focus audio 25 output to the localized area 30 adjacent to the display 15, according to an example. In an example, the processor 45 may control the automatic operations of the first speaker 60 and the second speaker 65 without the need of user intervention by programming the processor 45 with controlling instructions to operate the first speaker 60 and the second speaker 65.

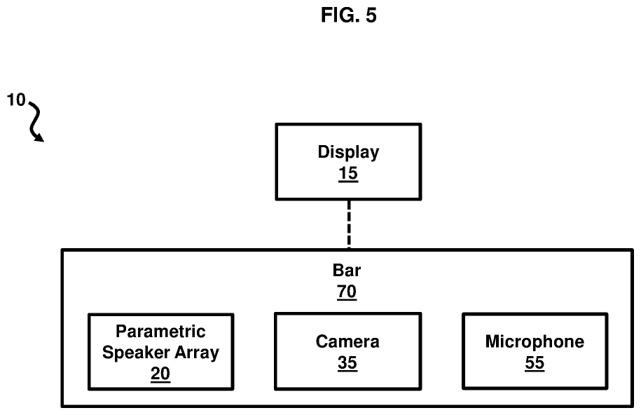

FIG. 5, with reference to FIGS. 1 through 4, illustrates that the computing device 10 may comprise a rotatable bar 70 operatively connected to the display 15. In an example, the parametric speaker array 20, the camera 35, and the microphone 55 are arranged on the rotatable bar 70. The rotatable bar 70 may be attached to the display 15 or embedded into the framing/housing of the display 15. Additionally, the rotatable bar 70 may be attached to the top, side, or bottom of the display 15. In some examples, the rotatable bar 70 may automatically rotate or may rotate by user control. For example, the processor 45 may control the automatic operations of the rotatable bar 70 without the need of user intervention by programming the processor 45 with controlling instructions to operate the rotatable bar 70. According to an example, the rotatable bar 70 may be an elongated mechanism that contains the parametric speaker array 20, the camera 35, and the microphone 55. Moreover, the parametric speaker array 20, the camera 35, and the microphone 55 may be spaced apart from each other at suitable locations on the rotatable bar 70. Furthermore, the rotatable bar 70 may be connected by a gear or wheel mechanism, not shown, to permit rotation of the rotatable bar 70 without rotating or moving the display 15. According to some examples, the rotational movement of the rotatable bar 70 may be in any suitable rotational movement with respect to the display 15.

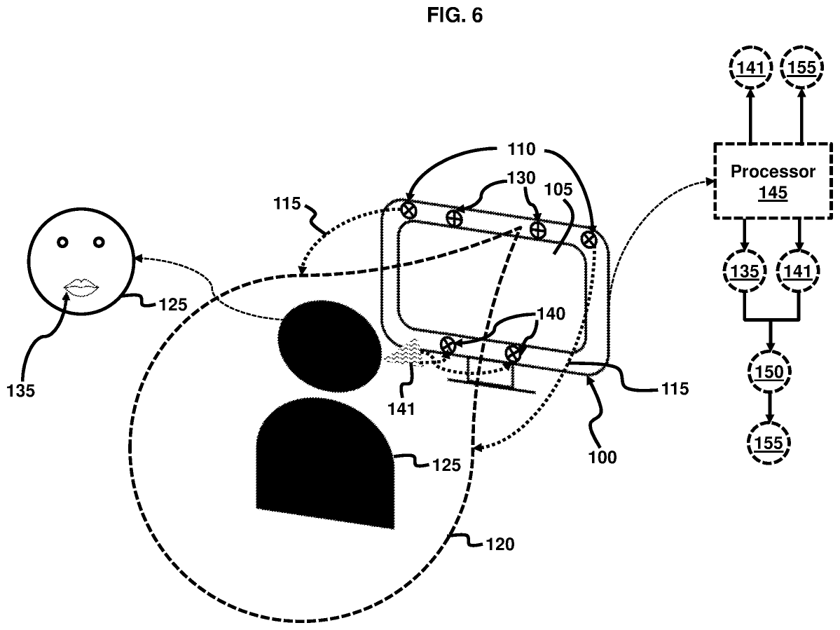

FIG. 6, with reference to FIGS. 1 through 5, illustrates a schematic diagram of an electronic device 100 comprising a display 105 with a user 125 positioned in front of the display 105. In some examples, the electronic device 100 may comprise a smartphone, a tablet computer, a laptop computer, a desktop computer, or an AIO computer, etc. The electronic device 100 may be an integrated computer comprising a computing/processing portion and the display portion; i.e., the display 105. As an AIO computer, the electronic device 100 may be positioned on a table or desk without the need for space for a bulky computing tower or other case typical of desktop computers since the computing/processing portion is integrated with the display portion. The electronic device 100 may comprise any suitable size, shape, and configuration. In an example, the electronic device 100 may be used as a video conferencing tool to permit remote communications between communicatively linked devices. Moreover, the electronic device 100 may be arranged to be coupled/docked with external components, peripherals, and devices. The display 105 may be any suitable type of display device including flat panel displays, curved displays, touchscreen displays, LCDs, LED displays, or a combination thereof.

A parametric speaker array 110 is attached to the display 105. The parametric speaker array 110 is to focus audio 115 output to a localized area 120 adjacent to the display 105. Moreover, the localized area 120 is set to accommodate the user 125. In an example, the parametric speaker array 110 may be embedded into the framing/housing of the display 105. The parametric speaker array 110 may include a speaker or a set of speakers that operate in the ultrasonic frequencies; i.e., above approximately 20 kHz and use modulated ultrasonic transducers, a drive circuit, and an audio source linked to the electronic device 100 to transmit ultrasonic beams to selectively modulate air to provide directional output of audio 115. In an example, the drive circuit may comprise a power supply, a pulse width modulator, an amplifier, and an H-bridge switch, not shown. Signal processing techniques may be used to control the parametric speaker array 110 to isolate a region where the audio 115 is to be focused or localized.

The localized area 120 is a defined or controlled location, region, zone, bubble, field, or lobe that is created near the display 105 using a static/fixed or dynamic approach of focusing the audio 115 that is output from the parametric speaker array 110, and the audio 115 is localized or restricted to this localized area 120 due to the modulation of the audio 115 produced by the parametric speaker array 110. In a static/fixed approach, a user 125 is placed or is otherwise located in a predictable location so that the location, region, zone, bubble, field, or lobe may be created based on the location of the user 125; i.e., a selected circumference or other suitable shape around the user 125, etc. In a dynamic approach, an ultrasonic phased array is used to shape the location, region, zone, bubble, field, or lobe, which provides some flexibility in case the user 125 moves around. Either the static/fixed or dynamic approach may utilize selective positioning and aiming of the speaker(s) in the parametric speaker array 110 to control the propagation of the audio 115 in the localized area 120. Moreover, the audio frequency, positioning of the parametric speaker array 110, and other operational parameters of the parametric speaker array 110 may be adjusted on a case-by-case basis to control the location, region, zone, bubble, field, or lobe defining the localized area 120. By directionally controlling the audio 115 that is output by the parametric speaker array 110, a private listening environment may be created in the localized area 120 allowing only a user 125 or others located in the localized area 120 to receive the audio 115. In this regard, the parametric speaker array 110 may be rotated or may be otherwise movable to more selectively direct the focus of the audio 115 to be output by the parametric speaker array 110, which controls the position and limits of the localized area 120. In an example, the localized area 120 may be a substantially elongated lobe or cone-shaped area immediately in front of the display 105 and extending approximately four meters in length and progressively increasing in width from approximately 0.5-2 meters in width, although other shapes, sizes, and configurations are possible. According to an example, the overall localized area 120 may have regions that provide audio 115 that are clearer than audio 115 in other regions in terms of sound quality, clarity, volume, etc. For example, the region of the localized area 120 that is immediately in front of the display 105 extending approximately two meters in length may provide audio 115 that is clearer than other regions of the localized area 120, and it is in this region of focused audio 115 where the user 125 may be positioned.

A camera array 130 is attached to the display 105. According to an example, the camera array 130 may be embedded into the framing/housing of the display 105. In an example, the camera array 130 may be a digital camera having any suitable resolution, a webcam, network camera, 3D stereoscopic camera, or other type of camera that may be embedded in the electronic device 100 or attached to the electronic device 100 and that may be used to capture images and/or video. Furthermore, the camera array 130 may comprise multiple cameras and any suitable arrangement of sub-components to house the electronics and optics to operate the camera array 130. The camera array 130 is to detect lip movements 135 of the user 125. Accordingly, the camera array 130 may be selectively positioned to have a clear view of the lip movements 135 of the user 125. The lip movements 135 may be detected based on the shape produced by the lips of a user 125. Moreover, the camera array 130 may capture images, video, or a combination thereof to detect and capture the lip movements 135.

A microphone array 140 is attached to the display 105. The microphone array 140 may contain one or more microphones according to an example. In an example, the microphone array 140 may be attached to the display 105 or embedded into the framing/housing of the display 105. According to some examples, the microphone array 140 may be a USB, condenser, plug and play, or other suitable type of audio-capturing device. In this regard, the microphone array 140 may capture audio 141 from the localized area 120. In an example, the processor 145 may control the automatic operations of the microphone array 140 without the need of user intervention by programming the processor 145 with controlling instructions to operate the microphone array 140. The microphone array 140 is to receive audio 141 input from within the localized area 120 and perform directional voice detection and ambient noise reduction from the localized area 120. The microphone array 140 has directional sensitivity capabilities based on a positioning of the microphone array 140 as well as using multiple microphones, according to an example, that are spaced apart to permit voice input from the user 125 into some of the microphones and ambient noise input into the other microphones, which effectively cancels the ambient noise from being received and processed by the processor 145.

A processor 145 is operatively connected to the display 105. The processor 145 may be a digital signal processor, media processor, microcontroller, microprocessor, embedded processor, or other suitable type of processor, according to some examples. In an example, the processor 145 may control the automatic operations of the display 105, parametric speaker array 110, camera array 130, or a combination thereof without the need of user intervention by programming the processor 145 with controlling instructions to operate the display 105, parametric speaker array 110, camera array 130, or a combination thereof. The processor 145 is to identify speech patterns 150 from the lip movements 135 detected by the camera array 130 and from the audio 141 input received by the microphone array 140. In an example, the processor 145 is to identify the speech patterns 150 from the lip movements 135 using an artificial intelligence model such as deep learning or machine learning that is trained to receive the lip movements 135 detected by the camera array 130, analyze the shapes and configurations of the lips of the user 125, analyze the lip movements 135 as a sequence of images or a video, create a representation of the lip movements 135 in the form of speech patterns 150, and transcribe the speech patterns 150 into text 155. In some examples, the speech patterns 150 may be a word, or string of words, sound, phrase, sentence, or other patterns of speech that may be linked together for communication. According to an example, the speech patterns 150 and text 155 may be generated in real-time by the processor 145. The text 155 may be saved in memory, not shown, and which may be locally stored on the electronic device 100 or remotely stored; i.e., in the cloud or remote memory, etc. The artificial intelligence model executable by the processor 145 may utilize previously received lip movements in the form of images, video, or a combination thereof from the same or different user to become trained into learning and mimicking the patterns created by the lip movements 135 of the user 125 to generate the text 155. In another example, the artificial intelligence model executable by the processor 145 may utilize programmed computer-generated lip positions associated with specific words or sounds to compare with the lip movements 135 detected by the camera array 130, which is then used to generate the text 155. In an example, the microphone array 140 may be used to detect the audio 141 of a user 125 and combined with the lip movements 135 detected by the camera array 130 to help train the artificial intelligence model executable by the processor 145 and improve the identification and accuracy of the speech patterns 150 for generation into text 155.

The processor 145 is to transmit the text 155 and audio 141 input from the localized area 120. In some examples, the 155 may be presented on the display 105. In another example, the text 155 and audio 141 may be transmitted by the electronic device 100 to a communicatively linked device that is being used remotely in a video conferencing arrangement to be output by the communicatively linked device for the local user of that device.

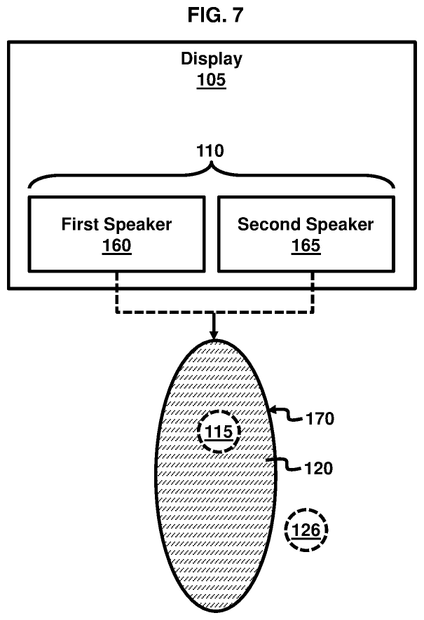

FIG. 7, with reference to FIGS. 1 through 6, illustrates that the parametric speaker array 110 may comprise a first speaker 160 positioned on the display 105, and a second speaker 165 positioned on the display 105. The first speaker 160 and the second speaker 165 may be attached to the display 105 or embedded into the framing/housing of the display 105. Moreover, the camera array 130 may be positioned on the display 105 such that the parametric speaker array 110 and camera array 130 may be respectively spaced apart and positioned at any suitable location on the display 105; i.e., top, side, bottom, front, back, etc. The first speaker 160 and the second speaker 165 may be suitably positioned and/or spaced apart from each other to provide directional audio 115 to the localized area 120. Accordingly, the first speaker 160 and the second speaker 165 are selectively positioned to generate a sound lobe 170 containing the localized area 120. The sound lobe 170 may be the size and/or shape of the localized area 120, according to an example. In some examples, the sound lobe 170 may be a tear-drop shape, elongated shape, elliptical shape, circular shape, or other shapes, which may be specifically generated based on the characteristics and operating parameters; i.e., frequency, spacing, positioning, number, etc. of the speakers in the parametric speaker array 110. According to an example, the size and/or shape of the sound lobe 170 may affect the clarity and volume of the audio 115 in the localized area 120. For example, a substantially elongated shaped sound lobe 170 may provide a sound volume of the audio 115 of 100% amplitude in a center beam area of the sound lobe 170; i.e., where a user 125 may be positioned, while the sound level of the audio 115 just beyond the center beam area of the sound lobe 170 may provide less than 10% amplitude. Accordingly, the audio 126 output outside of the sound lobe 170 is diminished compared with the audio 115 output within the sound lobe 170.

The first speaker 160 and the second speaker 165 may both operate in the ultrasonic frequencies; i.e., above approximately 20 kHz and may both use modulated ultrasonic transducers, a drive circuit, and an audio source linked to the electronic device 100 to transmit ultrasonic beams to selectively modulate air to provide directional output of audio 115. In an example, the drive circuit may comprise a power supply, a pulse width modulator, an amplifier, and an H-bridge switch, not shown. Signal processing techniques may be used to control the first speaker 160 and the second speaker 165 to isolate a region in the localized area 120 where the audio 115 is to be focused or localized. Moreover, the first speaker 160 and the second speaker 165 may be used in a complimentary manner to focus audio 115 output to the localized area 120 adjacent to the display 105, according to an example. In an example, the processor 145 may control the automatic operations of the first speaker 160 and the second speaker 165 without the need of user intervention by programming the processor 145 with controlling instructions to operate the first speaker 160 and the second speaker 165.

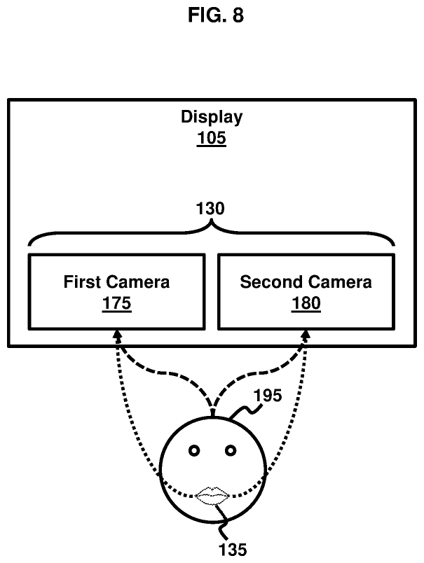

FIG. 8, with reference to FIGS. 1 through 7, illustrates that the camera array 130 may comprise a first camera 175 positioned on the display 105, and a second camera 180 positioned on display 105. The first camera 175 and the second camera 180 may be attached to the display 105 or embedded into the framing/housing of the display 105. Moreover, the first camera 175 may be spaced apart from the second camera 180, and may be positioned on the top, bottom, or side of the display 105. Accordingly, the first camera 175 and the second camera 180 are selectively positioned to collectively capture the lip movements 135 from different angles. In an example, the processor 145 may control the automatic operations of the first camera 175 and the second camera 180 without the need of user intervention by programming the processor 145 with controlling instructions to operate the first camera 175 and the second camera 180. The first camera 175 and the second camera 180 may be utilized in a complimentary manner such that they provide multiple lenses for the camera array 130. In this regard, the first camera 175 and the second camera 180 may provide two offset images or video to produce a 3D stereoscopic view of the captured images or video. The first camera 175 and the second camera 180 may be utilized for capturing the lip movements 135 of the user 125, which may aid in improving the identification of the speech patterns 150 and generation of the text 155 due to the 3D images or video of the lip movements 135 being robust and accurate representations of the lip movements 135 of the user 125. In this regard, the artificial intelligence model executable by the processor 145 may be trained using the 3D images and/or video captured by the first camera 175 and the second camera 180.

Moreover, the camera array 130 is to capture a 3D rendering 195 of the user 125. In this regard, the 3D rendering 195 of the user 125 may be a 3D image, video, or computer generated graphic that is utilized by the artificial intelligence model executable by the processor 145 to customize the speech patterns 150 attributed to a specific user 125. This may provide security for the use of the electronic device 100 such that the text 155 and audio 115 may not be generated or provided if an unauthorized user is attempting to engage the electronic device 100 or is positioned in the localized area 120 and the processor 145 attempts to match the face of the unauthorized user with the 3D rendering 195 of the user 125 and yields a non-match. In this regard, an unauthorized user may be an individual who has not been granted access rights to use the electronic device 100 and/or whose 3D rendering has not previously been set and/or programmed into the processor 145.

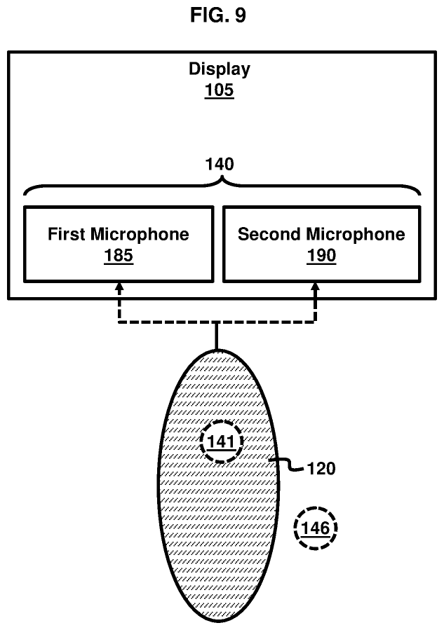

FIG. 9, with reference to FIGS. 1 through 8, illustrates that the microphone array 140 may comprise a first microphone 185 positioned on the display 105, and a second microphone 190 positioned on the display 105. In an example, the first microphone 185 and the second microphone 190 may be attached to the display 105 or embedded into the framing/housing of the display 105. According to some examples, the first microphone 185 and the second microphone 190 may each be a USB, condenser, plug and play, or other suitable type of audio-capturing device. In this regard, the first microphone 185 and the second microphone 190 may capture audio 141 from the localized area 120. The first microphone 185 and the second microphone 190 each has directional sensitivity capabilities based on a positioning of the first microphone 185 and the second microphone 190 with respect to each other and being spaced apart from each other to permit voice input from the user 125 into the first microphone 185, for example, and ambient noise input into the second microphone 190, for example, which effectively cancels the ambient noise from being received and processed by the processor 145. Accordingly, the first microphone 185 and the second microphone 190 are selectively positioned to receive the audio 141 input from within the localized area 120 and filter audio 146 detected from outside the localized area 120. Therefore, the first microphone 185 and the second microphone 190 are to perform directional voice detection and ambient noise reduction or cancelation from the localized area 120. In an example, the processor 145 may control the automatic operations of the first microphone 185 and the second microphone 190 without the need of user intervention by programming the processor 145 with controlling instructions to operate the first microphone 185 and the second microphone 190.

In some examples, the processor 45, 145 described herein and/or illustrated in the figures may be embodied as hardware-enabled modules and may be configured as a plurality of overlapping or independent electronic circuits, devices, and discrete elements packaged onto a circuit board to provide data and signal processing functionality within a computer. An example might be a comparator, inverter, or flip-flop, which could include a plurality of transistors and other supporting devices and circuit elements. The modules that are configured with electronic circuits process and/or execute computer logic instructions capable of providing digital and/or analog signals for performing various functions as described herein including controlling the operations of the computing device 10 or electronic device 100 and associated components. In some examples, the processor 45, 145 may comprise a central processing unit (CPU) of the computing device 10 or electronic device 100. In other examples the processor 45, 145 may be a discrete component independent of other processing components in the computing device 10 or electronic device 100. In other examples, the processor 45, 145 may be a microprocessor, microcontroller, hardware engine, hardware pipeline, and/or other hardware-enabled device suitable for receiving, processing, operating, and performing various functions for the computing device 10 or electronic device 100. The processor 45, 145 may be provided in the computing device 10 or electronic device 100, coupled to the computing device 10 or electronic device 100, or communicatively linked to the computing device 10 or electronic device 100 from a remote networked location, according to various examples.

The computing device 10 or electronic device 100 may comprise various controllers, switches, processors, and circuits, which may be embodied as hardware-enabled modules and may be a plurality of overlapping or independent electronic circuits, devices, and discrete elements packaged onto a circuit board to provide data and signal processing functionality within a computer. An example might be a comparator, inverter, or flip-flop, which could include a plurality of transistors and other supporting devices and circuit elements. The modules that include electronic circuits process computer logic instructions capable of providing digital and/or analog signals for performing various functions as described herein. The various functions can further be embodied and physically saved as any of data structures, data paths, data objects, data object models, object files, database components. For example, the data objects could include a digital packet of structured data. Example data structures may include any of an array, tuple, map, union, variant, set, graph, tree, node, and an object, which may be stored and retrieved by computer memory and may be managed by processors, compilers, and other computer hardware components. The data paths can be part of a computer CPU that performs operations and calculations as instructed by the computer logic instructions. The data paths could include digital electronic circuits, multipliers, registers, and buses capable of performing data processing operations and arithmetic operations (e.g., Add, Subtract, etc.), bitwise logical operations (AND, OR, XOR, etc.), bit shift operations (e.g., arithmetic, logical, rotate, etc.), complex operations (e.g., using single clock calculations, sequential calculations, iterative calculations, etc.). The data objects may be physical locations in computer memory and can be a variable, a data structure, or a function. Some examples of the modules include relational databases (e.g., such as Oracle® relational databases), and the data objects can be a table or column, for example. Other examples include specialized objects, distributed objects, object-oriented programming objects, and semantic web objects. The data object models can be an application programming interface for creating HyperText Markup Language (HTML) and Extensible Markup Language (XML) electronic documents. The models can be any of a tree, graph, container, list, map, queue, set, stack, and variations thereof, according to some examples. The data object files can be created by compilers and assemblers and contain generated binary code and data for a source file. The database components can include any of tables, indexes, views, stored procedures, and triggers.

Various examples described herein may include both hardware and software elements. The examples that are implemented in software may include firmware, resident software, microcode, etc. Other examples may include a computer program product configured to include a pre-configured set of instructions, which when performed, may result in actions as stated in conjunction with the methods described herein. In an example, the preconfigured set of instructions may be stored on a tangible non-transitory computer readable medium or a program storage device containing software code.

FIGS. 10A through 10E, with reference to FIGS. 1 through 9, illustrate an example system 200 to provide directionally focused audio 25 in a localized area 30 and detect lip movements 40 of a user 31 to generate text 50 and speech 51. In the examples of FIGS. 10A through 10E, the computing device 10 comprises or is communicatively linked to the processor 45 and a machine-readable storage medium 205. Processor 45 may include a central processing unit, microprocessors, hardware engines, and/or other hardware devices suitable for retrieval and execution of instructions stored in a machine-readable storage medium 205. Processor 45 may fetch, decode, and execute computer-executable instructions 210 to enable execution of locally-hosted or remotely-hosted applications for controlling action of the computing device 10. The remotely-hosted applications may be accessible on remotely-located devices; for example, remote communication device 215, which is accessible through a wired or wireless connection or network 220. For example, the remote communication device 215 may be a laptop computer, notebook computer, desktop computer, computer server, tablet device, smartphone, or other type of communication device. As an alternative or in addition to retrieving and executing computer-executable instructions 210, the processor 45 may include electronic circuits including a number of electronic components for performing the functionality of the computer-executable instructions 210.

The machine-readable storage medium 205 may be any electronic, magnetic, optical, or other physical storage device that stores the computer-executable instructions 210. Thus, the machine-readable storage medium 205 may be, for example, Random Access Memory, an Electrically-Erasable Programmable Read-Only Memory, volatile memory, non-volatile memory, flash memory, a storage drive (e.g., a hard drive), a solid-state drive, optical drive, any type of storage disc (e.g., a compact disc, a DVD, etc.), and the like, or a combination thereof. In one example, the machine-readable storage medium 205 may include a non-transitory computer-readable storage medium. The machine-readable storage medium 205 may be encoded with executable instructions for enabling execution of remotely-hosted applications accessed on the remote communication device 215.

In an example, the processor 45 executes the computer-executable instructions 210 that when executed cause the processor 45 to perform computer-executable instructions 225-265. As provided in FIG. 10A, controlling instructions 225 control a parametric speaker (e.g., first speaker 60, second speaker 65, or a combination thereof) to constrain audio 25 output to a localized area 30 adjacent to the computing device 10. The audio 25 may be constrained to the localized area 30 by directionally focusing the audio 25 using a selected arrangement or position of the first speaker 60 and the second speaker 60, and/or due to the operating parameters of the first speaker 60 and the second speaker 60, such as the frequencies of the audio 25 that is being output. Controlling instructions 230 control a camera 35 to capture lip movements 40 of a user 31 in the localized area 30. The camera 35 may utilize 3D imaging and/or video to capture the lip movements 40, according to an example. Converting instructions 235 convert the lip movements 40 into text 50 and speech 51 using an artificial intelligence model executable by the processor 45, for example. In an example, the lip movements 40 may be mapped as a geometric configuration(s) of the shape(s) of the lips as a user 31 speaks, and the geometric configuration(s) may be compared to a previously-stored geometric configuration(s) associated with lip movements of the user 31 or other user that are attributed to particular text and speech, and by matching the corresponding geometric configurations, the text 50 and speech 51 may be generated.

As provided in FIG. 10B, comparing instructions 240 compare the lip movements 40 with previously received lip movements to improve an accuracy of a transcription of captured audio 56 by using artificial intelligence to generate any of the text 50 and the speech 51. In this regard, an artificial intelligence model executable by the processor 45 may be trained by using the previously received lip movements of a user 31 or another user to identify the shapes created by the lip movements 40 and associate the lip movements 40 and/or the previously received lip movements with the captured audio 56 in order to further enhance the accuracy of the transcription of the captured audio 56 in order to improve the accuracy of the text 50 and speech 51 generated by the processor 45. As provided in FIG. 10C, controlling instructions 245 control a microphone 55 to receive the captured audio 56 from the localized area 30. The microphone 55 may utilize noise cancelling techniques to remove ambient noise outside of the localized area 30 while only receiving and transmitting the captured audio 56 from the localized area to the processor 45 for processing. Generating instructions 250 generate text 50 comprising a transcription of the captured audio 56. In this regard, the accuracy of the text 50 may be improved by utilizing the captured audio 56.

As provided in FIG. 10D, identifying instructions 255 identify a voice associated with the captured audio 56. The artificial intelligence model executable by the processor 45 may be trained to learn the voice associated with a particular user 31 and associate the voice with the captured audio 56 through a comparison process. For example, the accent and other speech identifiers associated with the voice may be programmed into the processor 45 to link the voice to the captured audio 56 whenever the voice is detected by the microphone 55. Controlling instructions 260 control operations of the computing device 10 based on an identification of the voice. Once a matched voice has been associated with the captured audio 56, the computing device 10 may be accessible and utilized by the user 31. This may provide security for the use of the computing device 10 such that the text 50 and speech 51 may not be generated or provided if an unauthorized user is attempting to engage the computing device 10 or is positioned in the localized area 120 and the processor 45 attempts to match the captured audio 56 of the unauthorized user with the voice associated with the user 31 and yields a non-match. In this regard, an unauthorized user may be an individual who has not been granted access rights to use the computing device 10 and/or whose voice has not previously been set and/or programmed into the processor 45.

As provided in FIG. 10E, reducing instructions 265 reduce or lower a volume of the captured audio 56 required to generate any of the text 50 and the speech 51. In this regard, a user 31 may not be required to speak in a normal or above-normal tone or volume in order for the processor 45 to generate the text 50 or speech 51 because the camera 35 is operated to detect and capture the lip movements 40 of the user 31 and the processor 45 converts the lip movements 40 into the text 50 or speech 51 using the artificial intelligence model executable by the processor 45 without the need for the captured audio 56 to be above a whispered tone or volume. This may be utilized in a work environment or social environment where the user 31 does not wish to have his/her voice heard by those near the user 31.

The examples described herein eliminate the need for a user 31, 125 to utilize a headset or earphones when conducting a video conference or other video communication through a computing device 10 or electronic device 100. The examples provided herein also improve privacy by reducing the need to speak audibly in public spaces such as shared offices, airports, airplanes, coffee shops, public transportation, or in quiet environments such as a library. The computing device 10 or electronic device 100 is able to facilitate this aspect of privacy by utilizing lip reading technology through an artificial intelligence model executable by a processor 45, 145 that instructs a camera 35 or camera array 130 to detect and capture lip movements 40, 135 of the user 31, 125 and to identify speech patterns 150 and convert the lip movements 40, 135 into text 50, 155, and speech 51. Moreover, the computing device 10 or electronic device 100 is able to facilitate privacy by utilizing a parametric speaker array 20, 110 to focus audio 25, 115 to be output in a localized area 30, 120 where the user 31, 125 is positioned, and anybody outside of the localized area 30, 120 does not hear the audio 25, 115. This allows for an increase in the number of people in an office environment to be positioned in a shared setting without interfering with each other's video conferencing or interaction with his/her respective computing device 10 or electronic device 100.

Additionally, the examples described herein improve the security for access to the computing device 10 or electronic device 100 and/or a video conference to occur on the computing device 10 or electronic device 100 by utilizing a recognized 3D rendering 195 and/or voice of a user 31, 125 to authenticate valid access to the computing device 10 or electronic device 100. Furthermore, the utilization of lip movements 40, 135 to generate text 50, 155 and speech 51 offers an improvement to the accuracy of the generated text 50, 155 and speech 51 compared with only relying on speech-to-text conversion because relying solely on audio/speech from a user 31, 125 in order to generate text 50, 155 may suffer from lack of accurate detection and capturing due to noisy environments.

The present disclosure has been shown and described with reference to the foregoing exemplary implementations. Although specific examples have been illustrated and described herein it is manifestly intended that the scope of the claimed subject matter be limited only by the following claims and equivalents thereof. It is to be understood, however, that other forms, details, and examples may be made without departing from the spirit and scope of the disclosure that is defined in the following claims.

What is claimed is:

1. A computing device comprising:
a display;
a parametric speaker array operatively connected to the display, wherein the parametric speaker array is to focus audio output to a localized area adjacent to the display;
a camera operatively connected to the display, wherein the camera is set to capture lip movements of a user in the localized area; and
a processor operatively connected to the display, wherein the processor is to convert the lip movements into text and speech.

2. The computing device of claim 1, comprising a microphone to perform directional voice detection and ambient noise reduction from the localized area.

3. The computing device of claim 1, wherein the camera comprises a three-dimensional (3D) stereoscopic camera.

4. The computing device of claim 1, wherein the parametric speaker array comprises a first speaker and a second speaker positioned on the display, and wherein the camera is positioned on the display.

5. The computing device of claim 2, comprising a rotatable bar operatively connected to the display, wherein the parametric speaker array, the camera, and the microphone are arranged on the rotatable bar.

6. An electronic device comprising:
a display;
a parametric speaker array attached to the display, wherein the parametric speaker array is to focus audio output to a localized area adjacent to the display, and wherein the localized area is set to accommodate a user;
a camera array attached to the display, wherein the camera array is to detect lip movements of the user;
a microphone array attached to the display, wherein the microphone array is to receive audio input from within the localized area and perform directional voice detection and ambient noise reduction from the localized area; and
a processor operatively connected to the display, wherein the processor is to:
identify speech patterns from the lip movements detected by the camera array and from the audio input received by the microphone array;
transcribe the speech patterns into text; and
transmit the text and audio input from the localized area.

7. The electronic device of claim 6, wherein the parametric speaker array comprises:
a first speaker positioned on the display; and
a second speaker positioned on the display,
wherein the first speaker and the second speaker are selectively positioned to generate a sound lobe containing the localized area, and
wherein the audio output outside of the sound lobe is diminished compared with the audio output within the sound lobe.

8. The electronic device of claim 6, wherein the camera array comprises:
a first camera positioned on the display; and
a second camera positioned on display,
wherein the first camera and the second camera are selectively positioned to collectively capture the lip movements from different angles.

9. The electronic device of claim 6, wherein the camera array is to capture a three-dimensional (3D) rendering of the user.

10. The electronic device of claim 6, wherein the microphone array comprises:
a first microphone positioned on the display; and
a second microphone positioned on the display,
wherein the first microphone and the second microphone are selectively positioned to receive the audio input from within the localized area and filter audio detected from outside the localized area.

11. A machine-readable storage medium comprising computer-executable instructions that when executed cause a processor of a computing device to:
control a parametric speaker to constrain audio output to a localized area adjacent to the computing device;
control a camera to capture lip movements of a user in the localized area; and
convert the lip movements into text and speech.

12. The machine-readable storage medium of claim 11, wherein the instructions, when executed, further cause the processor to compare the lip movements with previously received lip movements to improve an accuracy of a transcription of captured audio by using artificial intelligence to generate any of the text and the speech.

13. The machine-readable storage medium of claim 12, wherein the instructions, when executed, further cause the processor to:
control a microphone to receive the captured audio from the localized area; and
generate text comprising the transcription of the captured audio.

14. The machine-readable storage medium of claim 13, wherein the instructions, when executed, further cause the processor to:
identify a voice associated with the captured audio; and
control operations of the computing device based on an identification of the voice.

15. The machine-readable storage medium of claim 13, wherein the instructions, when executed, further cause the processor to reduce a volume of the captured audio required to generate any of the text and the speech.
